(19) United States
(12) Patent Application Publication
(10) Pub. No.: US 2021/0092117 A1
(43) Pub. Date: Mar. 25, 2021

(54) INFORMATION PROCESSING

(71) Applicant: Beijing Sensetime Technology Development Co., Ltd., Beijing (CN)

(72) Inventors: Fan ZHANG, Beijing (CN); Binxu PENG, Beijing (CN)

(21) Appl. No.: 17/111,809

(22) Filed: Dec. 4, 2020

Related U.S. Application Data
(63) Continuation of application No. PCT/CN2018/123172, filed on Dec. 24, 2018.

(30) Foreign Application Priority Data
Jun. 5, 2018 (CN) 201810568908.0

(51) Int. Cl. H04L 29/06; G06F 21/32; G06F 21/44; G06K 9/62

(52) U.S. Cl. CPC H04L 63/0876; H04L 63/0861; G06K 9/6202; G06F 21/44; G06F 21/32

(57) ABSTRACT

The embodiments of the present disclosure provide information processing methods and apparatuses, electronic devices, and storage media. One of the methods includes: obtaining first information of a target object, the first information including first identification information; obtaining second information of the target object, the second information comprising second identification information; comparing the second identification information with the first identification information; in response to that the second identification information and the first identification information meet a matching condition, associating the first information and the second information.

### CROSS-REFERENCE TO RELATED APPLICATION

This application is a continuation of International Application No. PCT/CN2018/123172 filed on Dec. 24, 2018, which claims priority to Chinese Patent Application No. 201810568908.0. 4 filed on Jun. 5, 2018, the disclosure of all of which is incorporated herein by reference in their entirety.

### TECHNICAL FIELD

The present disclosure relates to, but is not limited to, a field of information technology, and in particular to methods, apparatuses, electronic devices and storage media for processing information.

### BACKGROUND

With the development of information technology, service modes for providing services to users based on statistical data analysis have emerged. However, the accuracy of providing services to users based on the statistical data analysis is still insufficient, and sometimes the needs of users may not be met accurately.

### SUMMARY

In view of this, the embodiments of the present disclosure provide information processing methods and apparatuses, electronic devices and storage media.

The technical solutions of the present disclosure are realized as follows:

According to a first aspect, an embodiment of the present disclosure provides an information processing method, including:

obtaining first information of a target object, the first information comprising first identification information;

obtaining second information of the target object, the second information comprising second identification information;

comparing the second identification information with the first identification information;

in response to that the second identification information and the first identification information meet a matching condition, associating the first information any the second information.

According to a second aspect, an embodiment of the present disclosure provides an information processing apparatuses, including:

a first obtaining module, configured to obtain first information of a target object, wherein the first information comprises: first identification information;

a second obtaining module, configured to obtain second information of the target object, the second information comprises: second identification information;

a comparing module, configured to compare the first identification information with the second identification information;

a first associating module, configured to, in response to that the second identification information and the first identification information meet a matching condition, associate the first information and the second information.

According to a third aspect, an embodiment of the present disclosure provides an electronic device, including:

a memory;

a processor connected to the memory and configured to implement by executing computer executable instructions stored on the memory.

According to a fourth aspect, an embodiment of the present disclosure provides a computer storage medium storing computer executable instructions; the computer executable instructions are executed to implement the information processing method provided by one of the foregoing technical solutions.

According to a fifth aspect, an embodiment of the present disclosure provides a computer program product including computer executable instructions, the computer executable instructions are executed to implement the information processing method provided by one of the foregoing technical solutions.

The information processing methods and apparatuses, the electronic devices and the storage media provided by the embodiments of the present disclosure compare the identification information in two types of information comprising first information and second information after obtaining the two types of information, and associate the first information and the second information if the matching succeeds (i.e. satisfying a preset matching condition). Through associating information of different types based on the matching of the identification information therein, subsequent information analysis statistics can be facilitated, such as the information on the same target object can be obtained more comprehensively, and targeted reference services can be provided subsequently according to a target user, thereby providing accurate targeted services.

### BRIEF DESCRIPTION OF THE DRAWINGS

FIG. 1 illustrates a flowchart of a first method of information processing according to some embodiments of the present disclosure.

FIG. 2 illustrates a structural schematic diagram of an information processing system according to some embodiments of the present disclosure.

FIG. 3 illustrates a flowchart of a second method of information processing according to some embodiments of the present disclosure

FIG. 4 illustrates a flowchart of a third method of information processing according to some embodiments of the present disclosure.

FIG. 5 illustrates a structural schematic diagram of an information processing apparatus according to some embodiments of the present disclosure.

FIG. 6 illustrates a structural schematic diagram of an electronic device according to some embodiments of the present disclosure.

### DETAILED DESCRIPTION OF THE EMBODIMENTS

The technical solutions of the present disclosure are further described in detail below in conjunction with the accompanying drawings and specific embodiments of the description.

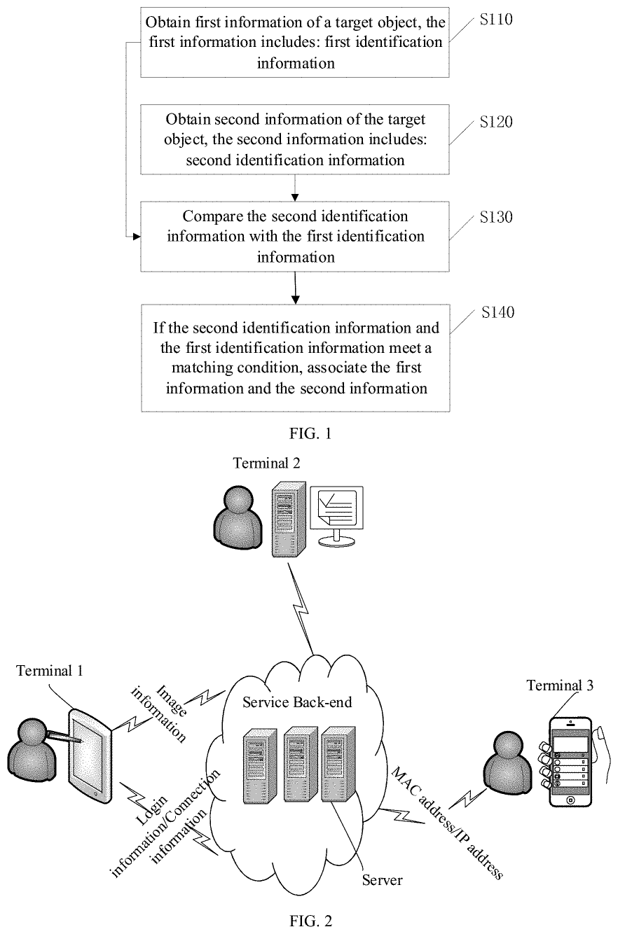

As shown in FIG. 1, this embodiment provides an information processing method, including the following steps.

At step S110, first information of a target object is obtained, the first information includes: first identification information.

At step S120, second information of the target object is obtained, the second information includes: second identification information.

At step S130, the second identification information is compared with the first identification information.

At step S140, in response to that the second identification information and the first identification information meet a matching condition, the first information and the second information are associated.

The information processing method provided in this embodiment may be applied to electronic device such as a database or a back-end server. FIG. 2 illustrates an information processing system, including: a service back-end, and the service back end includes one or more servers. The above method may be applied to a server. FIG. 2 shows a terminal 1, a terminal 2 and a terminal 3. It should be noted that three types of terminals are shown in FIG. 2. However, the terminals that connect to the server can be of various types, for example, various mobile terminals or fixed terminals, which are not limited to FIG. 2. The terminal may submit image information, login information, media access control (MAC) address, Internet protocol (IP) address, and connection information to the server.

The target object may be an object that views or collects various types of content data, for example, a person or an information device that can actively collect information.

The first information of the target object is obtained, and the second information of the target object is obtained. Firstly, the first information and the second information are of different types, and secondly, the two types of information can be information from different sources. For example, the first information may be data generated when a user actively accesses the Internet; the second information may be data generated by the user and collected by an electronic device such as a monitoring system when the user does not access the Internet. In a word, the difference between the first information and the second information can be manifested in: different sources of information, different ways of obtaining information corresponding to active participation of the user and passive information collection on the user, etc.

In some embodiments, the obtaining of the first information and/or the second information may include: automatically generating by the electronic device, receiving from other electronic devices, and collecting from a sensor. In a word, there are many ways of obtaining information, and is not limited to any one of the above.

In some other embodiments, the first information may be information generated by a first platform, and the second information may be information generated by a second platform. The first platform and the second platform are different. In some cases, the first platform and the second platform may be a relatively independent platform.

For the convenience of subsequent processing of information, in this embodiment, the first identification information included in the first information may be compared with the second identification information included in the second information. If they are matched, a matching condition is considered to be met, and the first information and the second information are associated.

Through the match of the first identification information and the second identification information, the first information and the second information may be determined as belonging to a same target object. Therefore, different types of information of the same target object are associated. As such, upon retrieving the identification information of a target object, more comprehensive information of the target object can be retrieved, or when one type of information of the target object is retrieved, other types of information of the target object can be retrieved at the same time. By realizing the association between different types of information on the same target object, subsequent information retrieval is simplified, and the efficiency of information retrieval is improved.

In the above embodiment, associating the first information and the second information may include at least one of the following:

simultaneously storing the first information and the second information in a same database and/or a same record;

setting an access entrance to the second information in an information record of the first information, where the access entrance may be various information such as a link, for obtaining the second information, for example, setting a storage address of a storage table where the second information is stored as a foreign key of the first information, and the second information may be accessed through the foreign key;

setting an access entrance to the first information in the information record of the second information; and

combining the second information and the first information. For example, the first information is record information of an online purchase of a user for a certain type of product, and the second information is the record information of an offline purchase for this type of product, the record information of online purchase can be combined with the record information of offline purchase according to the record information of the second information to obtain purchase record information of the user for the certain type of product.

In a word, if the first information and the second information are associated, when one of the first information and the second information is retrieved, the other one can be obtained at the same time. As such, after associating the first information and the second information, problems of missing information in searching for information based on analysis and statistics are reduced, and problems of inaccurate analysis and statistics caused by incomplete information searching are reduced. In addition, the problem of insufficient service accuracy caused by inaccurate analysis and statistics is further solved.

In this embodiment, the first information may also include object data in addition to the first identification information; the second information may also include object data in addition to the second identification information.

The object data may include at least one of the following:

behavior data for describing behaviors of an object such as a user;

attribute data for describing attributes of an object such as a user.

The behavior data may include data such as network behavior data, dressing behavior data, and consumption behavior data, which indicates various behavior features.

The behavior features may be used to describe at least the following:

movement feature of the object.

As such, second content data can be selected by combining a geographic attribute tag and a behavior feature tag.

The attribute data may be various information indicating at least one of the following of the user: identity feature, preference feature, physiological appearance feature, and social relationship.

The identity feature may be used to describe at least one of the following:

gender of the object,

age of the object,

nationality of the object.

The physiological appearance feature may include at least one of the following:

height of the object;

weight (fat or thin) of the object;

skin color of the object;

facial features of object.

The preference feature may be used to describe at least one of the following:

an interested object of the object;

a disliked object of the object.

For example, some users like animals such as kittens and puppies, but may hate animals with sharp mouths or fur. As such, upon selecting the second content data, content data containing the interested object of the user may be selected and displayed based on the preference feature, and content data containing the disliked object may be avoided for the user to select.

In some embodiments, step S130 may include: preprocessing the first information and the second information; and associating the preprocessed first information and the preprocessed second information.

Preprocessing the first information and the second information may include at least one of the following:

upon storing the first information and the second information in association, deleting redundant information in the first information and redundant information in the second information, where the redundant information may include: same information or similar information having different expressions of a same meaning included in the first information and the second information, so as to reduce the storage of information;

upon storing the first information and the second information in association, performing safety process on confidential information in the first information and confidential information in the second information. The safety process may include: deleting the confidential information and performing desensitization process on the confidential information. The confidential information may include: private information and the like. Deleting the confidential information may include: deleting confidential information that is irrelevant to subsequent data processing; performing the desensitization process may include: performing deformation process on confidential information that is relevant to the subsequent data processing, for example, deforming information by replacing a specific age with an age group, so as to ensure that, on one hand, the desensitized information can be used for the subsequent data processing, and on the other hand, the confidentiality of the original information, and reduce information safety issues.

In some embodiments, associating the first information and the second information includes:

storing the first information and the corresponding second information in a same database or a same storage area.

storing the first information and the corresponding second information may include:

storing the first information and the second information according to a preset data structure, which may include:

obtaining a required data item by parsing the first information and the second information;

obtaining the structured information by storing the first information and the second information according to the data item.

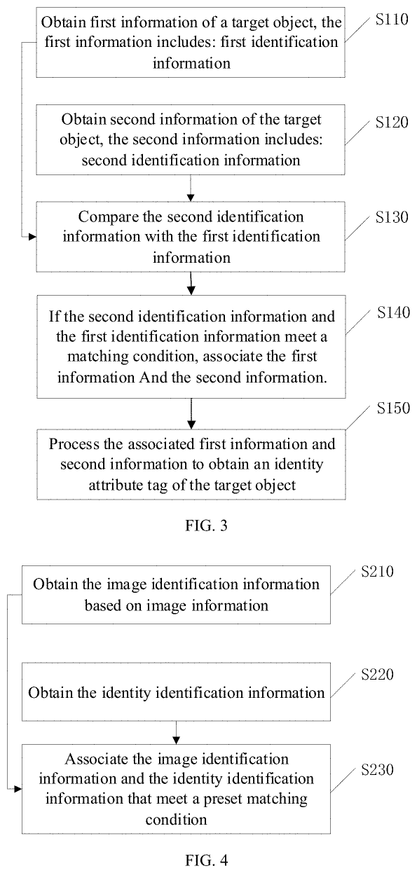

In some embodiments, as shown in FIG. 3, the method further includes step S150.

At step S150, an identity attribute tag of the target object is obtained by processing the associated first information and second information.

The identity attribute tag may be various tagged information describing at least one of the following features of the target object: identity feature, preference feature, behavior feature, appearance feature, and current emotional state feature.

In some embodiments, the method further includes:

providing targeted service to the target object according to the identity attribute tag. The service may include: news pushing service, friend adding service, etc.

For example, providing news that a user interested in according to the identity attribute tag of the user; for another example, providing social friends with high similarity of the user, such as QQ friends or WeChat friends according to the identity attribute tag of the user.

In some other embodiments, the method further includes:

pushing content data to a client or user terminal where the first identification information corresponding to the identity attribute tag is located according to the identity attribute tag. The content data may include: one or more of the following information: a government announcement, a commercial advertisement, a charity advertisement, an event promotion, etc.

In still some other embodiments, the method further includes:

pushing the content data to the user according to a scene tag of a scene where the target object is currently located and the identity attribute tag.

As such, content data such as an advertisement may be pushed subsequently to the target object according to the identity attribute tag.

The scene tag may include: a geographic location tag and/or a service function tag:

The geographic location tag may describe characteristics of a geographic location, for example, the location is at seaside or in a mountainous area. The service function tag can describe the service function of a current location where the target object is located. For example, when in a hotel, the service function tag may be a hotel attribute tag; for another example, when at a public transportation station such as an airport, the service function tag may be a public transportation station attribute tag; for still another example, in a cafe, the service function tag may be a cafe attribute tag.

In some embodiments, obtaining the identity attribute tag of the target object may include:

performing information processing on the data item and obtaining the identity attribute tag based on the data item.

In some embodiments, the first identification information includes: at least two types of identification information of the target object.

In some other embodiments, step S120 may include:

comparing the second identification information with the at least two types of identification information respectively.

In this embodiment, the first identification information includes at least two types of identification information, where the at least two types of identification information may be: identification data of different types of information, or identification data of a same type of information for identifying the target object from different dimensions.

The identification data of different information types may include:

image identification data for identifying the target object through image data, for example, identify the identity of a target user; for example, identifying a person through facial image information; identifying a person through eye images;

text identification information, for identifying the target object through a communication identification such as an ID card number, a passport number, a mobile phone number or WeChat ID of the target user.

For example, using textualized facial feature information and mobile phone number may correspond to the same type of identification data representing the same target object in different dimensions.

Step S130 may include:

in response to that the second identification information is matched with at least one of the at least two types of identification information, associating the first information and the second information.

Since the first identification information includes identifications of at least two target objects, only one identification information in the second identification information needs to be matched successfully, so that the association of the first information and the second information in step S130 can be performed.

In some embodiments, the at least two types of identification information include image identification information of the target object and identity identification information of the target object.

The image identification information of the target object may include: facial information or facial feature information. In some embodiments, the image identification information may also include: biometric information of the target object scanned by image acquisition such as fingerprint information, iris information, etc.

The identity identification information of the target object may include, for example, an instant communication identification of the user such as an ID card number, a passport number, a mobile phone number, a WeChat ID, and a Weibo ID.

In a word, there are various types of specific information content of the image identification information and the identity identification information, and the specific implementation is not limited to any of the foregoing.

In some embodiments, in order to ensure that the image identification information in the first identification information can reflect the feature of the face of the target object in a recent time period, the method further includes:

updating the image identification information in the first identification information regularly or irregularly. For example, requesting photos taken in the recent time period by a user of a terminal device corresponding to the device identification information in the first identification information, and forming the image identification information based on the requested photos, so as to improve the matching success of the image identification information.

In some embodiments, the identity identification information includes at least one of the following:

device identification information; and

communication identification information.

The device identification information may be: a device identification of the device held by the target object.

The communication identification information may be an identification used by the target object in various communication processes.

The device identification information includes at least one of the following:

an international mobile equipment identity (IMEI) of the device;

a MAC address of the device.

The communication identification information includes at least one of the following:

an international mobile subscriber identity (IMSI) of the device;

a mobile communication identification;

an instant communication identification.

The mobile communication identification may include: the mobile phone number of the user, and a temporary identity identification allocated by the network based on the mobile phone number or the device identification information.

The instant communication identification may include an identification of various instant communication software, such as a WeChat ID or a Weibo ID of the user.

The communication identification information may also include: an application identification of an application used by another user, for example, an Alipay account number, a mailbox number, and an application identification of an image acquisition application.

In some other embodiments, the communication identification information may further include: an Internet protocol (IP) address used by the user to access the Internet.

In a word, there are many types of communication identification information, which is not limited to any one of the foregoing.

In this embodiment, the first identification information includes at least two types of identification information. As such, when the associated first information and second information are used on different platforms, there can be corresponding identification information, which can be identified and applied, thereby achieving the application of data from different platforms.

For example, sending content data to the electronic device held by the target user can be performed based on the device identification information of the electronic device held by the user. As such, the information application scenarios of the associated first information and second information are expanded and an utilization rate of effectively using the information is improved.

In some embodiments, the at least two types of identification information may include at least one common identification information that can be used across platforms, and the common identification information may be identified by at least two different platforms; typical cross-platform identification information may include: the device identification information of the device held by the user and the instant communication identification information that can be migrated across platforms.

In some embodiments, the method further includes:

forming the first identification information containing the at least two types of identification information of the target object by associating the at least two types of identification information.

In this embodiment, the method further includes: forming the first identification information of the target object by associating the at least two types of identification information.

In some embodiments, the step of forming the first identification information of the target object by associating the at least two types of identification information may be included in step S110. In response to that the first identification information is formed by associating the two types of identification information, the first identification information may be stored in a preset database. Step S110 may include: reading the first identification information from the preset database.

In some other embodiments, in response to that the first identification information of the target object is not formed by associating the at least two types of identification information in advance, step S110 may be associating the at least two types of identification information of the target object to obtain the first identification information.

Associating the at least two types of identification information may include:

receiving the at least two types of identification information input by the target object from a human-computer interaction interface, for example, with an authorization of the target object, receiving the at least two types of identification information of the target object from the human-computer interaction interface;

with the authorization of the target object, associating the at least two types of identification information of the target object automatically. For example, when the user logs in a preset application using a mobile phone and uses the application to take a selfie which includes an facial image of the user, the facial image can be used to form an image identification information; meanwhile, the user may automatically submit the mobile phone number or the MAC address of the mobile phone when the user actually logged in to the preset application, then at least two types of identification information of the target object are automatically obtained.

The at least two types of identification information may include: the image identification information and the identity identification information. In some embodiments, as shown in FIG. 4, forming the first identification information of the target object by associating the at least two types of identification information may include the following steps.

At step S210, the image identification information is obtained based on image information.

At step S220, the identity identification information is obtained.

At step S230, the image identification information and the identity identification information that meet a preset matching rule are associated.

The preset matching rule may include:

a source matching rule which requires that the image information and the identity information are provided by a same user terminal or a same client;

and/or,

a spatio-temporal matching rule which requires that the image information and the device identification information are collected at a same or similar time and space.

In some embodiments, based on the source matching rule, associating the image identification information and the identity identification information that meet the preset matching rule includes:

in response to that the image information and the device identification information are provided by a same user terminal, associating the image identification information and the identity identification information;

and/or,

in response to that the image information and the device identification information are provided by a same client, associating the image identification information and the identity identification information.

The client here may be any type of program or software development kit.

In some embodiments, based on the source matching rule, associating the image identification information and the identity identification information that meet the preset matching rule includes:

obtaining the identity identification information based on login information and/or connection information of a preset client, where the identity information includes: the device identification information and/or the communication identification information;

receiving the image information collected by the preset client;

obtaining the image identification information of the target user based on the image information;

forming the first identification information by associating the image identification information and the identity identification information.

The preset client needs to submit the device identification information such as an IP address or a MAC address to log in when logging in to a server. As such, the identity identification information may be obtained from the login information. In some embodiments, the login information may also be a client ID of the preset client and the like.

The connection information may indicate that the preset client may not log in but request a connection, and the device identification information such as IP address or MAC address may also be used when requesting the connection. As such, one or more types of the identity identification information may be obtained based on the login information and/or the connection information.

The preset client may be a client having an image acquisition function, and the client may include various image applications, for example, a photograph application or an album application.

For example, a preset client may collect facial images of different users. In some embodiments, obtaining the image identification information of the target user based on the image information includes: extracting, from image information of a plurality of images, facial information with a highest appearance frequency as the image identification information.

For another example, the preset client may collect facial images of different users. In some embodiments, obtaining the image identification information of the target user based on the image information includes: recording time information of different collected objects, selecting the image information with the largest time span and generating the image identification information or directly using the image information as the image identification information. For example, some users may not in favor of taking photos, so their mobile phones, wearable devices or other user devices rarely collect images of the users. Since the user devices are used by the users, and the collected images of the user appear for a long period of time since the user started to use the user device. As such, image information of the object with the largest time span may be selected to generate the image identification information or be directly used as the image identification information.

The image identification information may be the one indicating the clearest appearance feature of the target object or reaching a preset definition among the plurality of image information, or the one indicating the most comprehensive appearance features or at least including a specified feature of the target object among the plurality of image information. The image identification information may be image information indicating features of a target area (for example, face or eyes) of the target object after sensitive information is removed through image processing. In a word, in this embodiment, by processing the plurality of image information, the image information that meets a selection condition is selected to generate or be used as the image identification information. As such, the matching accuracy of the first information and the second information when being compared subsequently may be improved.

In some other embodiments, in response to that a time difference between an acquisition timing of the image information and a detected timing of the identity identification information is less than a preset time difference, and an acquisition location of the image information and a detection location of the identity identification information are in a same space, the spatio-temporal matching rule is met.

In some embodiments, based on the spatio-temporal matching rule, associating the image identification information and the identity identification information that meet the preset matching rule includes:

in response to that the spatio-temporal matching rule is met at least twice, and the image information corresponding to the spatio-temporal matching rule at least twice contains graphic information of a same collected object, associating the image identification information, formed based on the graphic information, and the identity identification information.

Based on the spatio-temporal matching rule, associating the image identification information and the identity identification information that meet the preset matching rule includes:

obtaining first image information collected at a first timing in a preset space and obtaining first identity identification information detected at the first timing;

obtaining second image information collected at a second timing in the preset space and obtaining second identity identification information detected at the second timing;

comparing the first image information and the second image information to obtain matched graphic information;

obtaining matched identity identification information by comparing the first identity identification information with the second identity identification information;

in response to that the matched graphic information indicates the same object is collected and detected at both the first timing and the second timing and the matched identity identification information exists, the first identification information is obtained by associating the image identification information corresponding to the matched graphic information with the matched identity identification information.

For example, on a certain day, the first image information of three guests in the lobby of hotel A is collected, and at the same time, based on WiFi detection and other technologies, or in response to that the three guests use their mobile phones to access the WiFi of hotel A, MAC addresses of the mobile phones of the three guests are obtained. On another day, the second image information of four guests in the lobby of hotel A is collected, also based on the WiFi detection, MAC addresses for the four guests are obtained. Then through comparing the MAC addresses, one of the MAC addresses detected in the two days is found to be the same. At the same time, by comparing the first image information with the second image information, a facial image in the image information collected in the two days is found to be of a same guest. As such, the facial image of the guest may be extracted as the image identification information, and the same MAC address may be used as the identity identification information of the guest, and the image identification information and the MAC address may be associated to achieve the association between image identification information and identity identification information. As such, the first identification information is obtained.

In some embodiments, in order to ensure that the image identification information and the identity identification information in the first identification information both correspond to the same object, in response to that the matched graphic information indicates that the same object is collected and detected at both the first timing and the second timing and the matched identity identification information exists, associating the image identification information corresponding to the matched graphic information and the matched identity identification information further includes: obtaining third image information provided by the device corresponding to the matched identity identification information, in response to that the third image information includes the graphic information of the collected object, forming the first identification information by associating the image identification information corresponding to the matched graphic information and the matched identity identification information.

The above method can ensure the accuracy of the first identification information.

In some embodiments, the first identification information includes at least two types of identification information, and the at least two types of identification information includes at least: a first identification and a second identification.

In order to facilitate the subsequent targeted searching and speed up the searching, the first identification and the second identification are stored in different databases; and/or, the second information including the first identification and the second information including the second identification are stored in different databases.

In some embodiments, the method further includes at least one of the following:

storing the first identification in a first database;

storing the second information including the first identification in a second database;

storing the second identification and/or the second information including the second identification in a third database;

storing the first information including both the first identification and the second identification in a fourth database;

In this embodiment, the at least two types of identification information are of different types. As such, when different platforms use different types of identification information to record information, the different types of identification information may be all matched with the first information. In some embodiments, at least one of the first identification and the second identification is a common identification. For example, the first identification is a common identification, and the second identification may be an in-platform identification in a specific platform.

As such, storing information separately with different databases facilitates the management of subsequent information, reduces information searching operations during information processing, and improves the efficiency of the information processing.

In some embodiments, step S130 may include: in response to that the second identification information and the first identification information meet the matching condition, storing the first information and the second information in association with each other in the fourth database.

As such, upon generating the identity attribute tag, the information records in the fourth database may be processed to obtain the identity attribute tag.

in response to that the comparison of the first information and the second information is completed, the corresponding second information is deleted from the second database or the third database to reduce information redundancy and reduce unnecessary storage space consumption.

In some embodiments, step S110 may include: receiving the first information of the target object from a preset client, where the first identification information includes image information; and step S130 may include: obtaining the second information from other information sources other than the preset client.

For example, the preset client may be a client provided by the storage platform itself, and the second information may be of other clients or other platforms. Therefore, in this embodiment, the first information and the second information comes from different clients, and at least one of them comes from the preset client, and the other one comes from clients or platforms other than the preset client.

As shown in FIG. 5, this embodiment provides an information processing apparatuses, including:

a first obtaining module 110, configured to obtain first information of a target object, the first information including first identification information;

a second obtaining module 120, configured to obtain second information of the target object, the second information comprising second identification information.

a comparing module 130, configured to compare the first identification information with the second identification information.

a first associating module 140, configured to, in response to that the second identification information and the first identification information meet a matching condition, associate the first information and the second information.

The information processing apparatus may be applied to various electronic devices, for example, applied to a physical machine or a virtual machine of a cloud platform.

The first obtaining module 110, the second obtaining module 120, the comparing module 130, and the first associating module 140 can all be program modules. After the program module is executed, the first information may be obtained, the second information may be obtained, the first identification information and the second identification may be compared, and the first identification information and the matched second identification information may be associated.

In an example, the apparatus includes:

The first identification information includes: at least two types of identification information of the target object.

The comparing module 130 is configured to compare the second identification information with the at least two types of identification information separately.

In some embodiments, the first associating module 140 is configured to, in response to that the second identification information matches with at least one of the at least two types of identification information, associating the first information and the second information.

In this embodiment, the first identification information includes at least two types of identification information, and if the second identification information matches one of the at least two types of identification information successfully, it can be considered that the first identification information matches the second identification information successfully. For example, the second identification information is a facial image, and the facial image is matched with the facial image in the first identification information. If it indicates that the two facial images are collected images of a same target object, it can be considered that the aforementioned matching condition is met.

In some embodiments, the at least two types of identification information include image identification information of the target object and identity identification information of the target object.

In some embodiments, the image identification information may also include at least one of the following: facial information, iris information, and fingerprint information.

In some embodiments, the identity identification information includes at least one of the following: device identification information, communication identification information.

In some embodiments, the device identification information includes at least one of the following: an IMEI of the device; and a MAC address of the device.

In addition, the communication identification information includes at least one of the following: a mobile communication identification; an instant communication identification.

In some embodiments, the apparatus further includes:

a second associating module, configured to form the first identification information containing the at least two types of identification information of the target object by associating the at least two types of identification information.

The second associating module may generate a first identification information containing the at least two types of identification information for association. There are many ways of generating the first identification information containing the at least two types of identification information. For details, please refer to the foregoing embodiment, which will not be repeated here.

In some embodiments, the second associating module is configured to obtain the identity identification information according to login information and/or connection information of a preset client, wherein the identity identification information includes: device identification information and/or communication identification information; receive image information collected by the preset client; obtain the image identification information of the target user based on the image information; and form the first identification information by associating the image identification information and the identity identification information.

In some embodiments, the second associating module is configured to extract, from image information of a plurality of images, facial information with the highest appearance frequency as the image identification information.

In other embodiments, the second associating module is configured to obtain first image information collected at a first timing in a preset space and obtain first identity identification information detected at the first timing; obtain second image information collected at a second timing in the preset space and obtain second identity identification information detected at the second timing; obtain matched graphic information by comparing the first image information with the second image information; obtain matched identity identification information by comparing the first identity identification information with the second identity identification information; in response to that the matched graphic information indicates that a same object is collected and detected at both the first timing and the second timing, the matched identity identification information exists, associate the image identification information corresponding to the matched graphic information and the matched identity identification information to obtain the first identification information.

In addition, the first identification information includes at least two types of identification information, and the at least two types of identification information includes at least: a first identification and a second identification; and/or, the second information including the first identification and the second information including the second identification are stored in different databases.

In some embodiments, the apparatus further includes:

a storing module configured to store the first identification in a first database; store the second information including the first identification in a second database; store the second identification and/or the second information including the second identification in a third database; store the first information including both the first identification and the second identification in a fourth database.

In this embodiment, information is classified and stored based on whether the information contains the first identification and/or the second identification, which facilitates the classified storage and classified management of the information, and reduces the information query operation in the subsequent use of the information.

In some embodiments, the first associating module 140 is configured to, in response to that the second identification information and the first identification information meet the matching condition, storing the first information and the second information in association with each other in the fourth database.

In some embodiments, the first obtaining module 110 is configured to receive the first information of the target object from a preset client, where the first identification information includes image information; and the second obtaining module is configured to obtain the second information from other information sources other than the preset client.

Several specific examples are provided below in conjunction with any of the foregoing embodiments:

obtaining first-party data, which may correspond to the first information;

obtaining third-party data, which may correspond to the second information;

mining object data;

storing data;

communicating data, which is the association of different types of information.

An example of the first-party data can be as follows:

The first-party data may include: international mobile equipment identity (IMEI)/identifier for advertisement (IDFA)/operating system identification (for example, Android system identification or IOS system identification)/operation System version (OS_Version)/user identification (UID)/universally unique identifier (UUID); network type (Network_type)/location information such as latitude and longitude; SDK version (SDK_Version)/application version (APP_Version); MAC address/IP address; email; device information such as device manufacturer/hardware name/phone product name/device model; application information such as a list of installed applications in the operating system (for example, Andorid or IOS); desensitized user photos, etc. A source of the first-party information may be: a preset client (for example, a preset software development kit (SDK)) and an application. The preset client may include a virtual reality or augmented reality software toolkit or application.

The image information of the application and a return of device identification information can also provide the identity identification information of the user. The obtained information may include: scene, address, point name; ID card_MD5 encrypted with algorithm MD5; stay time; advertisements watched, number of viewers, age, gender, duration of watching, expression, and stay time of the viewers; MAC address; on-site photos; non-private information such as guest flow and guest flow distribution.

The third-party data may obtain a hotel address and a hotel name through software such as SenseFocus or SDK, and the hotel information can be supplemented through Baidu Map, Ctrip, Lianjia and other websites.

An example of the third-party data mining can be as follows:

The third-party data may include hotel attributes which may include: hotel star; hotel grade; standard room price; the name of the business district where the hotel is located; hotel type; prices of surrounding hotels; names and types of landmarks near the hotel, etc.

The third-party data may also include guest attributes which may include: guest photos; encrypted information of the ID information of the guest for check-in; non-private information such as the duration and times of the guest watching an advertisement; the type of hotel or room the guest checks in, etc. The guest attributes here do not refer to specific individuals, but only to the overall guest attributes of the hotel.

The user attribute is one of the object data. The following provides an example of user attribute mining:

| Data type | Data entry |
|---|---|
| Offline ID | Mapping of identity ID_MD5/MAC address/face |
| | information (FaceID). |
| Permanent | Permanent residence; type of permanent residence; |
| residence | housing prices around the permanent residence. |
| Office | Office; |
| location | Name of the business district where the office is |
| | located. |
| Interests | Commonly used media; |
| | Frequent consumption points; |
| | Interested advertisements. |
| Travel | Recently visited place; |
| related | Travel frequency; |
| | Frequently visited area; |
| | Vacation frequency; |
| | Whether ever traveled abroad; |
| | Countries traveled abroad. |
| Commonly | Glasses; |
| worn | Clothing; |
| accessories | Hat; |
| | Bag. |

Storing various information according to the following table:

| Name | Description |
|---|---|
| Library 1 | A complete association of FaceID, online device ID |
| (correspond | (including IMEI/Android_ID/IDFA/MAC . . .) |
| to the fourth | and tags is finished |
| database) | |
| Library 2 | Only online ID such as IMEI/Android_ID/IDFA/MAC, |
| (correspond | but no FaceID |
| to the third | |
| database) | |
| Library 3 | Only FaceID and a small amount of offline information, |
| (correspond | but the communication with other online data has not |
| to the second | been realized |
| database) | |
| Library 4 | Only FaceID information |
| (correspond | |
| to the first | |
| database) | |

The online information here can be information that a user uses a preset client; the offline information can be information that the user does not actively use the network but information is collected under authorization.

For example, based on a mobile phone device ID, an application ID (IMEI/IDFA/Android_ID/OS_Version/UID/UUID, etc.), a record for each user is created and listed in Library 2.

For example, facial images may be collected, and the collected facial images are classified and the most frequently appeared facial images indicate the host of the phone; the quality of the images of the host is evaluated, and the image with a higher quality is selected (requires quality evaluation algorithm) for generating the FaceID of the host, and the FaceID is stored into Library 1.

The image of the host is updated regularly (such as half a year), and the FaceID is updated.

All the data used above may be data that has been desensitized, and does not refer to specific individuals. Only desensitized profile portraits or overall portraits of a certain type of user are used.

The offline part is based on various image applications, such as image acquisition applications, image beautification applications, image fun applications or social applications with image functions, etc.

If the capability of MAC address collection is available, the matching relationship between multiple identification information can be obtained by a match of the ID_MD5 and the MAC address that appear in the hotel at the same time for more than twice, so that a complete first identification information is obtained.

The method of data communication may be as follows.

For example, with MAC addresses, the online information and offline information can be associated through a match of MAC addresses;

For example, without MAC address offline, only with ID_MD5 and FaceID, the online information and offline information can be associated through a match of FaceID, which is implemented by:

comparing the facial images collected at the hotel with the facial images of customers (for example, customers who have used a preset client to submit photos in the hotel) near the hotel during a same time period, and selecting records with a highest similarity which is higher than a threshold for association.

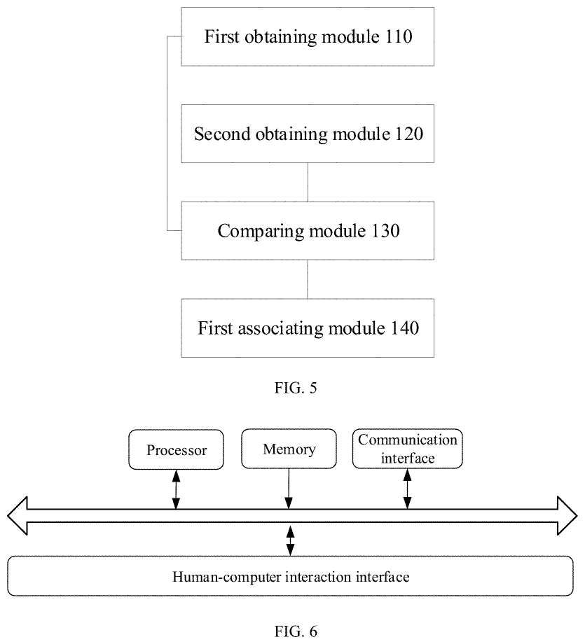

As shown in FIG. 6, this embodiment provides a terminal device, including:

a memory;

a processor connected to the memory and configured to implement one or more of the foregoing information processing methods provided by one or more technical solutions, for example, one or more of the information processing methods shown in FIGS. 1, 3 and 4, applied in one or more of a second private network, a database and a first private network by executing computer executable instructions stored on the memory.

The memory may be of various types, such as a random access memory, a read-only memory, a flash memory, or the like. The memory may be used for information storage, for example, storing computer executable instructions and the like. The computer executable instructions may be various program instructions, such as target program instructions and/or source program instructions.

The processor may be of various types, for example, a central processor, a microprocessor, a digital signal processor, a programmable array, a digital signal processor, an application specific integrated circuit, an image processor, or the like.

The processor may be connected to the memory via a bus. The bus may be an integrated circuit bus or the like.

In some embodiments, the terminal device can further include a communication interface, and the communication interface can include a network interface, for example, a local area network interface, a transmitting/receiving antenna, and the like. The communication interface is also connected to the processor and can be used for information transmission and reception.

In some embodiments, the terminal device further includes a human-computer interaction interface, for example, the human-computer interaction interface may include various input/output devices, for example, a keyboard, a touch screen, and the like.

This embodiment provides a computer storage medium storing computer executable instructions, the computer executable instructions are executed to implement one or more of the foregoing information processing methods provided by one or more technical solutions, for example, one or more of the information processing methods shown in FIGS. 1, 3 and 4.

The computer storage medium may be various recording media with a recording function, for example, storage medium such as a CD, a floppy disk, a hard disk, a magnetic tape, an optical disk, a U disk, or a mobile hard disk. Optionally, the computer storage medium may be a non-transitory storage medium. The computer storage medium may be read by a processor. Thus, after the computer executable instructions stored in the computer storage mechanism are acquired and executed by the processor, the information processing method provided by any one of the foregoing technical solutions can be implemented. For example, the information processing method applied to the terminal device or the information processing method in the application server may be executed.

This embodiment further provides a computer program product including computer executable instructions; the computer executable instructions are executed to implement the information processing method provided by the foregoing one or more technical solutions, for example, one or more of the information processing methods shown in FIG. 1 and/or FIG. 2.

The computer program includes a computer program tangibly contained in a computer storage medium, the computer program includes program code for executing the methods shown in the flowcharts, and the program code may include instructions corresponding to the step of executing the methods provided in the embodiments of the present disclosure. The program product may be various application programs or software development kits.

In some embodiments provided in the present disclosure, it should be understood that the disclosed apparatus and method may be implemented in other ways. The apparatus embodiments described above are merely schematic, for example, the division of the units is merely a logical function division, and there may be another division manner in actual implementation, for example, a plurality of units or components may be combined, or may be integrated into another system, or some features may be ignored or not performed. Moreover, the coupling, or direct coupling, or communication connection between the components shown or discussed may be through some interfaces, indirect coupling or communication connection of devices or units, and may be electrical, mechanical, or other forms.

The units described as separate components may or may not be physically separate, and components displayed as units may or may not be physical units, that is, may be located in one place or may be distributed over a plurality of network units. Some or all of the units may be selected according to actual needs to achieve the purpose of the solution of the embodiments of the present disclosure.

In addition, all the functional units in the embodiments of the present disclosure may be integrated into one processing module, or each unit separately serves as one unit, or two or more units may be integrated into one unit. The integrated units may be implemented in the form of hardware or in the form of units with functions of hardware and software.

Those with ordinary skill in the art may understand that all or part of the steps of the method embodiments may be implemented by a hardware related to program instructions, and the program may be stored in a computer readable storage medium, and when the program is executed, the steps including the method embodiments are executed. The storage medium includes a removable storage device, a read-only memory (ROM, Read-Only Memory), a random access memory (RAM, Random Access Memory), a magnetic disk, or an optical disk, and any other medium that can store program codes.

The above are merely specific embodiments of the present disclosure, but the scope of protection of the present application is not limited thereto, and any variation or replacement readily conceivable by a person skilled in the art within the technical scope disclosed in the present disclosure should be covered within the scope of protection of the present disclosure. Therefore, the scope of protection of the present disclosure should be based on the scope of protection of the claims.

1. An information processing method, comprising:
obtaining first information of a target object, the first information comprising first identification information;
obtaining second information of the target object, the second information comprising second identification information;
comparing the second identification information with the first identification information; and
in response to that the second identification information and the first identification information meet a matching condition, associating the first information and the second information.

2. The method of claim 1, wherein, the first identification information comprises at least two types of identification information of the target object, comparing the second identification information with the first identification information comprises:
comparing the second identification information with the at least two types of identification information separately.

3. The method of claim 2, wherein in response to that the second identification information and the first identification information meet a matching condition, associating the first information and the second information comprises:
in response to that the second identification information matches with at least one of the at least two types of identification information, associating the first information and the second information.

4. The method of claim 2, wherein, the at least two types of identification information comprises:
image identification information of the target object; and
identity identification information of the target object.

5. The method of claim 3, wherein, the at least two types of identification information comprises:
image identification information of the target object; and
identity identification information of the target object.

6. The method of claim 4, wherein, the image identification information comprises at least one of the following:
facial information;
iris information; and
fingerprint information.

7. The method of claim 4, wherein, the identity identification information comprises at least one of the following:
device identification information; and
communication identification information.

8. The method of claim 7, wherein, the device identification information comprises at least one of the following:
an international mobile equipment identity (IMEI) of a device; and
a media access control (MAC) address of the device.

9. The method of claim 7, wherein, the communication identification information comprises at least one of the following:
a mobile communication identification; and
an instant communication identification.

10. The method of claim 1, further comprises:
forming the first identification information containing at least two types of identification information of the target object by associating the at least two types of identification information.

11. The method of claim 10, wherein, forming the first identification information containing at least two types of identification information of the target object by associating the at least two types of identification information comprises:
obtaining identity identification information of the target object based on login information and/or connection information of a preset client, wherein the identity identification information comprises device identification information and/or communication identification information;
receiving image information collected by the preset client;
obtaining image identification information of the target object based on the image information;
forming the first identification information by associating the image identification information and the identity identification information.

12. The method of claim 11, wherein, obtaining the image identification information of the target object based on the image information comprises:
extracting, from the image information of a plurality of images, facial information with a highest appearance frequency as the image identification information.

13. The method of claim 10, wherein, forming the first identification information containing at least two types of identification information of the target object by associating the at least two types of identification information comprises:
obtaining first image information collected at a first timing in a preset space and first identity identification information detected at the first timing in the preset space;
obtaining second image information collected at a second timing in the preset space and second identity identification information detected at the second timing in the preset space;
obtaining matched graphic information by comparing the first image information with the second image information;
obtaining matched identity identification information by comparing the first identity identification information with the second identity identification information; and
in response to that the matched graphic information indicates that a same object is collected and detected at both the first timing and the second timing, and the matched identity identification information exists, associating the image identification information corresponding to the matched graphic information and the matched identity identification information to obtain the first identification information.

14. The method of claim 1, wherein,
the first identification information comprises at least two types of identification information, and the at least two types of identification information comprises at least a first identification and a second identification;
the first identification and the second identification are stored in different databases; and/or,
the second information comprising the first identification and the second information comprising the second identification are stored in different databases.

15. The method of claim 14, further comprising at least one of the following:
storing the first identification in a first database;
storing the second information comprising the first identification in a second database;
storing the second identification and/or the second information comprising the second identification in a third database; and
storing the first information comprising both the first identification and the second identification in a fourth database.

16. The method of claim 15, wherein, associating the first information and the second information comprises:
in response to that the second identification information and the first identification information meet the matching condition, storing the first information and the second information in association with each other in the fourth database.

17. The method of claim 1, wherein,
obtaining the first information of the target object comprises:
receiving the first information of the target object from a preset client, wherein the first identification information comprises image information;
obtaining the second information of the target object comprises:
obtaining the second information from information sources other than the preset client.

18. An electronic device comprising:
a memory storing computer executable instructions;
a processor connected to the memory and configured to perform the following operations by executing the computer executable instructions stored on the memory:
obtaining first information of a target object, the first information comprising first identification information;
obtaining second information of the target object, the second information comprising second identification information;
comparing the second identification information with the first identification information; and
in response to that the second identification information and the first identification information meet a matching condition, associating the first information and the second information.

19. A non-transitory computer storage medium storing computer executable instructions, which when executed by one or more processors cause the one or more processors to perform the following operations:
obtaining first information of a target object, the first information comprising first identification information;
obtaining second information of the target object, the second information comprising second identification information;
comparing the second identification information with the first identification information; and
in response to that the second identification information and the first identification information meet a matching condition, associating the first information and the second information.

20. A computer program product, wherein the computer program product comprises computer executable instructions; and the computer executable instructions are executed to implement the method of claim 1.
